(19) United States
(12) Patent Application Publication
(10) Pub. No.: US 2015/0131553 A1
(43) Pub. Date: May 14, 2015

(54) RADIO BASE STATION

(71) Applicant: Telefonaktiebolaget L M Ericsson (publ), Stockholm (SE)

(72) Inventors: Angelo Centonza, Winchester (GB); Muhammad Kazmi, Bromma (SE)

(73) Assignee: Telefonaktiebolaget L M Ericsson (publ), Stockholm (SE)

(21) Appl. No.: 14/399,445

(22) PCT Filed: May 8, 2013
(86) PCT No.: PCT/SE2013/050520

§ 371 Date: Nov. 6, 2014

Related U.S. Application Data
(60) Provisional application No. 61/644,459, filed on May 9, 2012.

(51) Int. Cl. H04L 5/00

(52) U.S. Cl. CPC H04L 5/0032
USPC 370/329

(57) ABSTRACT

A method of second radio network node (RNN) serving second UE, includes receiving a first message from interfering RNN causing interference to the second UE. The first message has information about first ABS pattern of the interfering RNN. A second usable ABS pattern is determined including protected subframes overlapping with subframes in the first ABS pattern. The second usable ABS pattern is used by the second RNN to configure the second UE with a second measurement resource restriction pattern (MRRP) for measurement on a neighbour cell. A second message is received from a first RNN serving a first UE, which has information about a first usable ABS pattern used by the first RNN configuring the first UE with a first MRRP for neighbour cell measurement. Using the first usable ABS pattern a neighbour cell list has neighbour cell(s) on which the second UE performs measurements in the second MRRP.

### TECHNICAL FIELD

The present disclosure relates to radio network nodes (also called radio base stations) and methods therein, in a radio communication system.

### BACKGROUND

In long term evolution (LTE) Release 10 (Rel-10) heterogeneous network, the serving evolved Node B (eNB) is required to signal a neighbour cell list along with a measurement pattern for enabling a user equipment (UE) to do neighbour cell measurements when multicast broadcast single frequency network (MBSFN) almost blank subframe (ABS) is used in aggressor cell (i.e. a cell causing interference to a victim cell) and/or when normal MBSFN (i.e. MBSFN data) is used in one or more neighbour cells. The creation of neighbour cell list requires considerable effort. This becomes more challenging in a heterogeneous network comprising of mixture of lower and higher power nodes and there can be a large number of lower power nodes in a small coverage area.

An aggressor (macro) cell sends information to neighbouring micro/pico/femto cells about the ABS pattern it has allocated. The neighbouring cell then uses this information to construct a usable ABS pattern comprising subframes in which the risk of interference from the aggressor cell is low based on the ABS pattern it has received information about. The neighbouring cell informs the aggressor cell about its usable ABS pattern. However, heterogeneous networks are becoming ever more complex and any neighbouring cell may e.g. experience interference from more than one aggressor cell, macro cells as well as other micro/pico/femto cells. This is not handled by in the communication standards today.

### SUMMARY

It is an objective of the present disclosure to solve a problem with the creation of neighbor lists in a heterogeneous network.

The network using Enhanced Inter-cell Interference Coordination (eICIC) will have to provide the neighbor cell list to the UE when MBSFN ABS is used in aggressor cell(s) and/or whenever the network uses MBSFN data in a neighbor cell. The network provides very limited information about the subframes in which the MBSFN is actually used in neighbor cells. For example the network indicates that whether MBSFN configuration in the serving and neighbor cells is the same or different. Therefore without a neighbor cell list the UE assumes that MBSFN is used in MBSFN-configurable subframes in all neighbor cells. When MBSFN ABS is used then the restricted subframes are typically also MBSFN-configurable. Hence in the absence of a neighbor cell list the UE assumes that a restricted subframe (MBSFN-configurable) configured for measurements in a neighbor cell contains Cell-specific Reference Signal (CRS) only in symbol #0 of the first slot of this subframe. Due to this assumption the UE will perform the neighbor cell measurements (e.g. Reference Signal Received Power (RSRP), Reference Signal Received Quality (RSRQ) etc) in CRS only in one out of four orthogonal frequency-division multiplexing (OFDM) symbols. This in turn results in degraded measurement performance. Therefore signaling of neighbor cell list is necessary whenever there is MBSFN in neighbor cell(s). However to ensure the neighbor cell list contains the correct cells considerable effort will be required in terms of network planning. Incorrect cells in the neighbor cell list may prevent the UE from reporting the measurements from neighbor cells, which are strong candidates for mobility (e.g. handover). Therefore due to incorrect neighbor cell list overall mobility performance will be deteriorated. A mechanism is needed to ensure the neighbor cell list contains correct list of cells.

It is according to the present disclosure, advantageous to allow the exchange of the ABS Status IE between any neighbor eNB. Namely, to enable RESOURCE STATUS UPDATE signalling including the ABS Status IE between X2 connected nodes (X2 being an interface between different network nodes) that were not previously involved in a request and allocation of ABS patterns. By enabling exchange of the ABS Status IE between any X2 connected node an eNB would be able to learn the ABS patterns used by its neighbor cells. This, combined with knowledge of the MBSFN subframes allocation at X2 connected neighbor eNBs, will give a serving eNB full view of the CRS configuration in all neighbor cells served by eNBs connected via X2 and of the protected resources used by such neighbor cells. Moreover, the above allows an eNB to construct a measSubframeCellList IE consisting of neighbor cells that can be measured by the UE during the measurement resource restriction patterns. Such list can be used to configure UE measurements.

By means of some embodiments of the present disclosure, creation of a neighbor cell list in a heterogeneous network is simplified.

By means of some embodiments of the present disclosure, it is ensured that all the neighbor cells which are interfered by aggressor cells and that utilize common protected resources to those in use at serving cell are included in the neighbor cell list when resource restriction measurement pattern is configured for neighbor cell measurements.

By means of some embodiments of the present disclosure, a UE is able to perform measurements using a measurement pattern in all neighbor cells which are interfered by the aggressor cell. This ensures that UE measurements are performed in restricted subframes in which aggressor cell interference is low.

According to an aspect of the present disclosure, there is provided a method in a second radio network node serving a second UE. The method comprises receiving a first message from an interfering radio network node which can cause interference to the second UE, said first message comprising information about a first ABS pattern allocated in said interfering radio network node. The method also comprises determining a second usable ABS pattern, said second usable ABS pattern comprising protected subframes overlapping with subframes comprised in the first ABS pattern, which second usable ABS pattern the second radio network node can use to configure the second UE with a second measurement resource restriction pattern for performing measurement on at least one neighbour cell. The method also comprises receiving a second message from a first radio network node serving a first UE, comprising information about a first usable ABS pattern used by said first radio network node to configure the first UE with a first measurement resource restriction pattern for performing measurement on at least one neighbour cell. The method also comprises preparing, based on the first usable ABS pattern, a neighbour cell list comprising neighbour cell(s) on which the second UE should perform measurements in the second measurement resource restriction pattern.

According to another aspect of the present disclosure, there is provided a method in a second radio network node serving a second UE. The method comprises sending a first message comprising a request to a first radio network node serving a first UE to transmit a second message comprising information about a first usable ABS pattern used by said first radio network node to configure the first UE with a first measurement resource restriction pattern for performing measurement on at least one neighbour cell. The first usable ABS pattern consists of protected subframes overlapping with subframes comprised in at least one of a plurality of ABS patterns received from at least a first and a second interfering network node which can cause interference to the first UE. The method also comprises receiving the second message from the first radio network node.

According to another aspect of the present disclosure, there is provided a computer program product comprising computer-executable components for causing a second radio network node to perform an embodiment of a method of the present disclosure when the computer-executable components are run on processor circuitry comprised in the second radio network node.

According to another aspect of the present disclosure, there is provided a second radio network node configured for serving a second UE. The second radio network node comprises processor circuitry, and a storage unit storing instructions that, when executed by the processor circuitry, cause the second radio network node to receive a first message from an interfering radio network node which can cause interference to the second UE, said first message comprising information about a first ABS pattern allocated in said interfering radio network node. The instructions also cause the second radio network node to determine a second usable ABS pattern, said second usable ABS pattern comprising protected subframes overlapping with subframes comprised in the first ABS pattern, which usable ABS pattern the second radio network node can use to configure the second UE with a second measurement resource restriction pattern for performing measurement on at least one neighbour cell. The instructions also cause the second radio network node to receive a second message from a first radio network node serving a first UE, comprising information about a first usable ABS pattern used by said first radio network node to configure the first UE with a first measurement resource restriction pattern for performing measurement on at least one neighbour cell. The instructions also cause the second radio network node to prepare, based on the first usable ABS pattern, a neighbour cell list comprising neighbour cell(s) on which the second UE should perform measurements in the second measurement resource restriction pattern.

According to another aspect of the present disclosure, there is provided a second radio network node configured for serving a second UE. The second radio network node comprises processor circuitry, and a storage unit storing instructions that, when executed by the processor circuitry, cause the second radio network node to send a first message comprising a request to a first radio network node serving a first UE to transmit a second message comprising information about a first usable ABS pattern used by said first radio network node to configure the first UE with a first measurement resource restriction pattern for performing measurement on at least one neighbour cell. The first usable ABS pattern consists of protected subframes overlapping with subframes comprised in at least one of a plurality of ABS patterns received from at least a first and a second interfering network node which can cause interference to the first UE. The instructions also cause the second radio network node to receive the second message from the first radio network node.

According to another aspect of the present disclosure, there is provided a computer program for a second radio network node configured for serving a second UE. The computer program comprises computer program code which is able to, when run on processor circuitry of the second radio network node, cause the second radio network node to receive a first message from an interfering radio network node which can cause interference to the second UE, said first message comprising information about a first ABS pattern allocated in said interfering radio network node. The code is also able to cause the second radio network node to determine a second usable ABS pattern, said second usable ABS pattern comprising protected subframes overlapping with subframes comprised in the first ABS pattern, which usable ABS pattern the second radio network node can use to configure the second UE with a second measurement resource restriction pattern for performing measurement on at least one neighbour cell. The code is also able to cause the second radio network node to receive a second message from a first radio network node serving a first UE, comprising information about a first usable ABS pattern used by said first radio network node to configure the first UE with a first measurement resource restriction pattern for performing measurement on at least one neighbour cell. The code is also able to cause the second radio network node to prepare, based on the first usable ABS pattern, a neighbour cell list comprising neighbour cell(s) on which the second UE should perform measurements in the second measurement resource restriction pattern.

According to another aspect of the present disclosure, there is provided a computer program for a second radio network node configured for serving a second UE. The computer program comprises computer program code which is able to, when run on processor circuitry of the second radio network node, cause the second radio network node to send a first message comprising a request to a first radio network node serving a first UE to transmit a second message comprising information about a first usable ABS pattern used by said first radio network node to configure the first UE with a first measurement resource restriction pattern for performing measurement on at least one neighbour cell. The first usable ABS pattern consists of protected subframes overlapping with subframes comprised in at least one of a plurality of ABS patterns received from at least a first and a second interfering network node which can cause interference to the first UE. The code is also able to cause the second radio network node to receive the second message from the first radio network node.

According to another aspect of the present disclosure, there is provided a method in a first radio network node serving a first UE. The method comprises receiving information about a plurality of ABS patterns allocated in interfering radio network nodes which can cause interference to the first UE. The receiving information about a plurality of ABS patterns comprises receiving a message from a first interfering radio network node which can cause interference to the first UE. The first message comprises information about a first ABS pattern allocated in said first interfering radio network node. The receiving information about a plurality of ABS patterns also comprises receiving a message from a second interfering radio network node which can cause interference to the first UE. The second message comprises information about a second ABS pattern allocated in said second interfering radio network node. The method also comprises determining a usable ABS pattern. The usable ABS pattern consists of protected subframes overlapping with subframes comprised in the plurality of ABS patterns. The usable ABS pattern can be used by the first radio network node to configure the first UE with a first measurement resource restriction pattern for performing measurement on at least one neighbour cell. The method also comprises sending a message comprising information about the determined usable ABS pattern to a second radio network node.

According to another aspect of the present disclosure, there is provided a computer program product comprising computer-executable components for causing a first radio network node to perform an embodiment of a method of the present disclosure when the computer-executable components are run on processor circuitry comprised in the first radio network node.

According to another aspect of the present disclosure, there is provided a first radio network node configured for serving a first UE. The first radio network node comprises processor circuitry, and a storage unit storing instructions that, when executed by the processor circuitry, cause the first radio network node to receive information about a plurality of ABS patterns allocated in interfering radio network nodes which can cause interference to the first UE. The receiving information about a plurality of ABS patterns comprises receiving a message from a first interfering radio network node which can cause interference to the first UE, said first message comprising information about a first ABS pattern allocated in said first interfering radio network node. The receiving information about a plurality of ABS patterns also comprises receiving a message from a second interfering radio network node which can cause interference to the first UE, said second message comprising information about a second ABS pattern allocated in said second interfering radio network node. The instructions also cause the first radio network node to determine a usable ABS pattern, said usable ABS pattern consisting of protected subframes overlapping with subframes comprised in the plurality of ABS patterns, which usable ABS pattern the first radio network node can use to configure the first UE with a first measurement resource restriction pattern for performing measurement on at least one neighbour cell. The instructions also cause the first radio network node to send a message comprising the determined usable ABS pattern to a second radio network node.

According to another aspect of the present disclosure, there is provided a computer program for a first radio network node configured for serving a first UE. The computer program comprises computer program code which is able to, when run on processor circuitry of the first radio network node, cause the first radio network node to receive information about a plurality of ABS patterns allocated in interfering radio network nodes which can cause interference to the first UE. The receiving information about a plurality of ABS patterns comprises receiving a message from a first interfering radio network node which can cause interference to the first UE, said first message comprising information about a first ABS pattern allocated in said first interfering radio network node. The receiving information about a plurality of ABS patterns also comprises receiving a message from a second interfering radio network node which can cause interference to the first UE, said second message comprising information about a second ABS pattern allocated in said second interfering radio network node. The code is also able to cause the first radio network node to determine a usable ABS pattern, said usable ABS pattern consisting of protected subframes overlapping with subframes comprised in the plurality of ABS patterns, which usable ABS pattern the first radio network node can use to configure the first UE with a first measurement resource restriction pattern for performing measurement on at least one neighbour cell. The code is also able to cause the second radio network node to send a message comprising the determined usable ABS pattern to a second radio network node.

According to another aspect of the present disclosure, there is provided a computer program product comprising an embodiment of a computer program of the present disclosure and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic illustration of an embodiment of a communication system comprising a macro eNB and a pico eNB, and a schematic signaling diagram of an embodiment of signaling between the macro eNB and pico eNB.

FIG. 2 is a schematic illustration of an embodiment of a heterogeneous communication system in accordance with the present disclosure.

FIG. 3 is a schematic flow chart of an embodiment of a method of the present disclosure.

FIG. 4 is a schematic flow chart of another embodiment of a method of the present disclosure.

FIG. 5 is a schematic flow chart of another embodiment of a method of the present disclosure.

FIG. 6 is a schematic flow chart of another embodiment of a method of the present disclosure.

FIG. 7 is a schematic illustration of an embodiment of a communication system comprising a macro eNB, a serving pico eNB and two neighbor eNBs, and a schematic signaling diagram of an embodiment of signaling between the different eNBs, in accordance with the present disclosure.

FIG. 8 is a schematic block diagram of an embodiment of a radio network (NW) node (also called radio base station, RBS) of the present disclosure.

FIG. 9 is a schematic illustration of an embodiment of a computer program product of the present disclosure.

### DETAILED DESCRIPTION

Embodiments will now be described more fully hereinafter with reference to the accompanying drawings, in which certain embodiments are shown.

However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

Pico cells are used to exemplify the present disclosure, but instead of pico cells, additionally or alternatively, micro cells and/or femtocells may be used. The radio network nodes serving the macro/micro/pico/femto cells of the present disclosure are exemplified as evolved Node B (eNB), but other radio network nodes, also called radio base stations, are also contemplated, e.g. Node B or other base stations able to communicate with each other over an X2 interface or similar.

In the present disclosure, several different subframe patterns are discussed. The ABS pattern of an aggressor cell (typically a macro cell) is the pattern of almost blank subframes and sub-frames of normal transmission activity within the radio frames as allocated in the aggressor cell to reduce interference in neighboring cells (typically smaller cells such as micro, pico and/or femto cells). The ABS pattern may be an MBSFN ABS pattern. The usable ABS pattern (also called protected (subframe) pattern), is the pattern of protected subframes used by a victim/neighbour cell based on the ABS pattern allocated in the aggressor cell. In accordance with the present disclosure, a victim cell can base its usable ABS pattern on information about allocated ABS patterns in more than one aggressor cell. Thus, a usable ABS pattern is obtained which can contain as many subframes as possible in view of a plurality of aggressor cell ABS patterns. For instance, only subframes which are protected by all aggressor cell ABS patterns may be included in the usable ABS pattern, or a subframe which is not protected by an ABS pattern of one aggressor cell, but is protected by an ABS pattern of another aggressor cell, may be included in the usable ABS pattern. Such a usable ABS pattern in view of a plurality of aggressor cell ABS patterns may be regarded as an overall usable ABS pattern of the victim cell. As discussed herein, current communication standards only relate usable ABS patterns to individual aggressor cells, why a victim cell may have one usable ABS pattern in relation to one aggressor cell, and another usable ABS pattern in relation to another aggressor cell. The usable ABS pattern is used by the victim cell to configure radio devices, also called user equipments (UEs), which are connected to the victim cell, with a measurement resource restriction pattern specifying the subframes in which the radio devices should perform measurements on neighbouring cells, e.g. for handover/mobility purposes or the like. The measurement resource restriction pattern may be the same for all radio devices connected to the victim cell, or different radio devices may receive different measurement resource restriction patterns from the victim cell. The measurement resource restriction patterns are signalled to the respective connected radio devices from the victim cell.

Below follow a description about the environment in which embodiments of the present disclosure may beneficially be used.

### Heterogeneous Network Deployment

In order to meet the requirement of higher data rates, there is interest to evolve the traditional macro cellular networks into a multi-layer or multi-tier network. A multi-layer or multi-tier is more commonly known as a heterogeneous network. The heterogeneous network comprises of two or more layers where each layer is served by one type of base station (BS) class or type. In other words the heterogeneous network contains a set of high power nodes and low power nodes in a geographical region. In a two-layered macro-pico heterogeneous network, the macro cell and pico cell layers may comprise of wide area base stations (aka macro base stations) and local area stations (aka pico base stations) respectively. The high data rate users located close to the pico base stations (i.e. in pico layer) can be offloaded from the macro layer to the pico layer. A more complex heterogeneous deployment may comprise of three layers namely macro layer, micro layer (which is served by medium range BS) and pico layer. Another more complex heterogeneous deployment may also comprise of three or four layers, namely macro layer, pico and/or micro layer and home base station or femto base station layer.

The heterogeneous network deployments are used to extend coverage in traffic hotspots, i.e. small geographical areas with a higher user density and/or higher traffic intensity where installation of low power nodes (e.g. pico nodes) can be considered to enhance the performance.

In co-channel heterogeneous network all layers operate on the same carrier frequency. On the other hand the heterogeneous network may also be deployed using multiple carriers (or frequencies) e.g. macro layer and pico layer on different carriers. However the co-channel deployment scenario is more attractive from the point of view of spectral efficiency.

Heterogeneous networks, and in particular the co-channel scenario, also brings more challenges in terms of managing interference. For example, the inter-cell interference experienced by the UE in the downlink and by the base station in the uplink needs to be mitigated. To address this, Inter-cell Interference Coordination (ICIC) and Enhanced ICIC (ECIC) techniques have been developed in the third generation partnership project (3GPP). For example, inter-cell interference coordination has the task to manage radio resources such that inter-cell interference is kept under control. ICIC mechanism includes a frequency domain component and time domain component. ICIC is inherently a multi-cell radio resource management (RRM) function that needs to take into account information (e.g. the resource usage status and traffic load situation) from multiple cells. The preferred ICIC method may be different in the uplink and downlink.

Time Domain eICIC:

In Rel-10, the time domain enhanced ICIC (aka eICIC) has been specified. In time domain scheme, there is resource partitioning in time domain between the aggressor cell and the victim cell to mitigate the interference towards the victim cells. This mechanism is being further enhanced in Rel-n.

According to the time domain eCIC scheme, the subframe utilization across different cells is coordinated in time through backhaul signaling, i.e. over X2 between eNBs. The subframe utilization is expressed in terms of a time domain pattern of low interference subframes or ‘low interference transmit pattern’. More specifically they are called Almost Blank Subframe (ABS) patterns. The Almost Blank Subframes (ABSs) are configured in an aggressor cell (e.g. macro cell) and are used to protect resources in subframes in the victim cell (e.g. pico cell) receiving strong inter-cell interference.

Almost blank subframes are subframes configured in an aggressor cell with reduced transmit power or no transmission power and/or reduced activity on some of the physical channels. In an ABS subframe, the basic common physical channels such as cell-specific reference signal (CRS), primary synchronization channel (PSS)/secondary synchronization channel (SSS), physical broadcast channel (PBCH) and System Information Block Type1 (SIB1) are transmitted to ensure the operation of the legacy UEs.

The ABS pattern can be non-MBSFN and MBSFN. In non-MBSFN ABS pattern, an ABS can be configured in any subframe (MBSFN or non-MBSFN configurable subframes). In MBSFN ABS pattern, an ABS can be configured in only MBSFN configurable subframes (i.e. subframes 1, 2, 3, 6, 7 and 8 in frequency division duplex (FDD) and subframes 3, 4, 7, 8 and 9 in time division duplex (TDD)).

The serving eNB signals one or more measurement patterns (aka measurement resource restriction pattern) to inform the UE about the resources or subframes which the UE should use for performing measurements on a target victim cell (e.g. serving pico cell and/or neighboring pico cells). The patterns are signaled to the UE via radio resource control (RRC) signaling in RRC_CONNECTED state. In later 3GPP releases, the pattern may also be configured in RRC_IDLE state. A measurement pattern may be a subset of an ABS pattern configured in an aggressor cell. 3o There are different patterns depending on the type of measured cell (serving or neighbor cell) and measurement type (e.g. RRM, radio link monitoring (RLM), channel state information (CSI) etc). More specifically, in Rel-10 there are three kinds of measurement resource restriction patterns that may be configured for the UE to measure on a victim cell. More patterns may be introduced in future releases.
Pattern 1: A single RRM/RLM measurement resource restriction for the primary cell (PCell).
Pattern 2: A single RRM measurement resource restriction for all or indicated list of neighbor cells operating in the same carrier frequency as the PCell.
Pattern 3: Resource restriction for CSI measurement of the PCell. If configured, two subframe subsets are configured per UE. The UE reports CSI for each configured subframe subset.

### Signaling of Neighbor Cell Information to UE:

In Rel-8, the signaling of the neighbor cell list to the UE to aid measurements is optional. This means the UE requirements are applicable even if the neighbor cell list is not signaled to the UE. Therefore UE blindly detects the neighbor cells, perform measurements on the identified cells and report the measurement results to the serving eNB.

In Rel-10 for eICIC, a parameter called “measSubframeCellList” is signaled to the UE via RRC as defined in 3GPP technical specification (TS) 36.331. It contains a list of cells for which “measSubframePatternNeigh” is applied. The parameter, “measSubframePatternNeigh” is the ‘time domain measurement resource restriction pattern’ applicable for doing reference signal received power (RSRP) and reference signal received quality (RSRQ) measurements in a neighbor cell on the indicated carrier frequency.

It has also been specified that for cells which are included in the neighbor cell list (i.e. in measSubframeCellList) the UE shall assume that the subframes indicated by measSubframePatternNeigh are non-MBSFN subframes.

A MBSFN subframe contains CRS only in the first symbol of the first time slot. Therefore the UE should not perform CRS based measurements (e.g. CSI, RSRP/RSRQ etc) in remaining orthogonal frequency-division multiplexing (OFDM) symbols of an MBSFN subframe. When MBSFN ABS pattern is used, then the victim cell measurement pattern (e.g. measSubframePatternNeigh) will also contain measurement subframes which are MBSFN-configurable subframes. Whenever MBSFN is used in any neighbor cell, the network also provides limited information to the UE that there is an MBSFN in a neighbor cell. More specifically the network signals a two-bit parameter called, “neighCellConfig”. This parameter provides very limited information related to MBSFN and TDD uplink (UL)/downlink (DL) configuration of neighbor cells on this carrier frequency. The two-bit information informs the UE that:
00: Not all neighbor cells have the same MBSFN subframe allocation as the serving cell on this frequency, if configured, and as the PCell otherwise
10: The MBSFN subframe allocations of all neighbor cells are identical to or subsets of that in the serving cell on this frequency, if configured, and of that in the PCell otherwise
01: No MBSFN subframes are present in all neighbor cells
11: Different UL/DL allocation in neighboring cells for TDD compared to the serving cell on this frequency, if configured, and compared to the PCell otherwise

When 00 is received, then the UE cannot know the MBSFN configuration used in neighbor cells. This is because the neighbor cells' MBSFN configuration is different than that used in the serving cell. The UE in other words does not know which MBSFN-configurable subframes are actually configured as MBSFN in neighbor cells. The consequence is that UE assumes that all MBSFN-configurable subframes are configured as MBSFN in all neighbor cells. This means that UE assumes that all these subframes (i.e. MBSFN-configurable subframes) in all neighbor cells contain CRS only in the first symbol in the first slot i.e. all MBSFN subframes are used as MBSFN.

This means in some scenarios such as when the MBSFN ABS pattern is used in an aggressor cell and the UE is required to measure using ‘measSubframePatternNeigh’ then the network will have to signal the neighbor cell list (i.e. measSubframeCellList) to the UE. This is to make sure that the UE assumes that the CRS is contained in all four OFDM symbols in a measurement subframe (which is potentially MBSFN configurable). This is according to the rule defined in TS 36.331 as stated above.

For cells in measSubframeCellList the UE shall assume that the subframes indicated by measSubframePatternNeigh are non-MBSFN subframes.

This in turn also ensures that the UE is able to meet the measurement requirements which are defined assuming that all CRS symbols are present in subframes in which the UE shall perform measurements. On the other hand, if UE assumes only one CRS symbol in a subframe, then it may fail the requirements. This implies that the network has to configure CRS in all four OFDM symbols in each restricted subframe included in a neighbor cell resource restriction pattern (e.g. in measSubframePatternNeigh information element (IE)) signalled to the UE for measuring the neighbor cells. If the four symbols with CRS are not configured in each such subframe, then the UE will not be required to meet the pre-defined measurement requirements related to restricted measurements. For example, it is stated in TS 36.133 that the measurement requirements for cells for which time domain measurement resource restriction patterns for performing E-UTRAN FDD intra-frequency measurements and evolved Universal Terrestrial Radio Access Network (E-UTRAN) TDD intra-frequency measurements, respectively, are configured by higher layers, provided that also the following additional conditions are fulfilled:
The time domain measurement resource restriction pattern configured for the measured cell indicates at least one subframe per radio frame for performing the intra-frequency measurements, and
Four symbols containing CRS are available in all subframes indicated by the time domain measurement resource restriction pattern.

### Signaling of ABS and MBSFN Information Over X2 Interface:

In current X2 application protocol (X2AP) protocol specifications captured in TS36.423, two mechanisms are defined to exchange information on ABS pattern allocation and utilization.

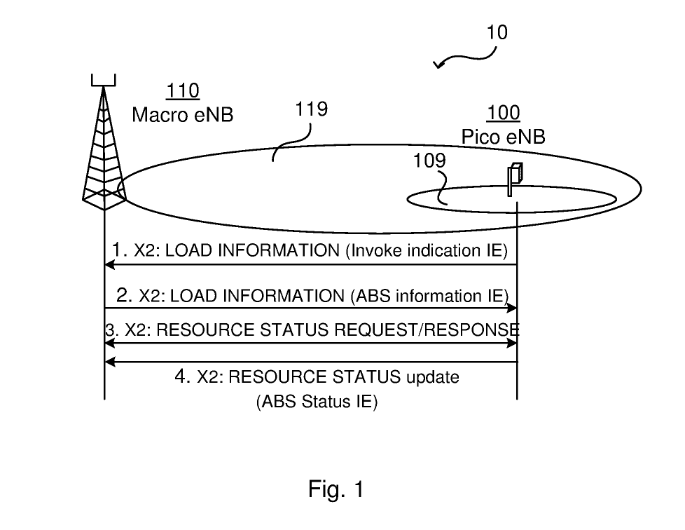

The first mechanism is the X2: LOAD INFORMATION procedure by means of which a victim (Pico) eNB may invoke allocation of ABS patterns at the aggressor (Macro) eNB. This occurs by including in the X2: LOAD INFORMATION message the Invoke Indication IE, as shown in FIG. 1, step 1. As a consequence of the ABS invoke message, the aggressor (macro) eNB may decide to allocate ABS patterns and to signal such patterns to the victim (Pico) eNB by including the ABS Information IE in a new X2: LOAD INFORMATION message to the victim eNB, see step 2 of FIG. 1.

Once the process of ABS pattern allocation is completed, current specifications allow the aggressor eNB to monitor the utilization of ABS subframes by means of requesting the ABS Status report. Such report is requested in the X2: RESOURCE STATUS REQUEST, where the fifth bit (Fifth Bit=ABS Status Periodic) of the Report Characteristic IE is set to 1. As a response, the victim eNB sends an X2: RESOURCE STATUS RESPONSE message, where the successful establishment of periodic reporting is confirmed (see step 3 of FIG. 1).

After configuration of the resource status reporting, the victim eNB sends periodic X2: RESOURCE STATUS UPDATE messages to the aggressor eNB, including the ABS Status IE. Such IE provides information about the subframes included in the ABS pattern allocated by the aggressor eNB that are used by the victim eNB to schedule UEs in adverse interference conditions. Information about ABS subframes utilization are included in the Usable ABS Pattern Info IE contained in the ABS Status IE. The Usable ABS Pattern Info IE semantics are defined in TS36.423 as follows:

“Each position in the bitmap represents a subframe, for which value “1” indicates ‘ABS that has been designated as protected from inter-cell interference by the eNB1, and available to serve this purpose for DL scheduling in the eNB2’ and value “0” is used for all other subframes.

The pattern represented by the bitmap is a subset of, or the same as, the corresponding ABS Pattern Info IE conveyed in the LOAD INFORMATION message from the eNB1.”

It is important to point out that the exchange of the ABS Status IE is currently possible only from the eNB that invoked allocation of an ABS pattern to the eNB that allocated the ABS pattern.

Besides the ABS information exchanged over X2, TS36.423 also allows the exchange of MBSFN subframe allocation between any eNBs connected via X2. Such exchange happens by means of the MBSFN Subframe Info IE included in the Served Cell Information IE. The Served Cell Information IE is included in the X2: X2 SETUP REQUEST and X2: X2 SETUP RESPONSE messages used to setup an X2 interface between two peer eNBs.

### UE Signal Level Measurements:

In order to support different functions such as mobility (e.g. cell selection, cell reselection, handover, RRC re-establishment, connection release with redirection etc), minimization of drive tests, self organizing network (SON), positioning etc., the UE is required to performed one or more measurements on the signals transmitted by the serving cell and the neighboring cells. Prior to do such measurements the UE has to identify a cell and determine its physical cell identity (PCI). Therefore PCI determination is also a type of measurement. In addition the UE performs measurements on signal strength or signal quality of a neighbor cell. Examples of signal level measurements which can be performed by the UE are RSRP and/or RSRQ in E-UTRAN or common pilot channel (CPICH) received signal code power (RSCP) and/or CPICH Ec/No (eceived Energy per Chip/power density in the band) in UTRAN or even GSM EDGE Radio Access Network (GERAN) carrier received signal strength indication (RSSI) or even pilot strength for CDMA2000/high rate packet data (HRPD). In connected mode, the UE reports the performed measurements to the serving network node.

### Positioning:

Several positioning methods for determining the location of the target device, which can be a UE, mobile relay, Personal Digital Assistant (PDA) etc. exist. The well known methods are:
Satellite based methods; it uses A—Global Navigation Satellite System (GNSS) (e.g. A—Global Positioning System (GPS)) measurements for determining UE position
Observed Time Difference of Arrival (OTDOA); it uses UE reference signal time difference (RSTD) measurement for determining UE position in LTE
Uplink-Time Difference of Arrival (UTDOA); it uses measurements done at Location Measurement Unit (LMU) for determining UE position
Enhanced cell ID; it uses one or more of UE Rx-Tx (receiver-transmitter) time difference, base station (BS) Rx-Tx time difference, LTE P/RSRQ, high speed packet access (HSPA) CPICH measurements, angle of arrival (AoA) etc for determining UE position. Fingerprinting is considered to be one type of enhanced cell ID method.
Hybrid methods; it uses measurements from more than one method for determining UE position

In LTE, the positioning node (aka Evolved Serving Mobile Location Center (E-SMLC) or location server) configures the UE, eNode B or LMU to perform one or more positioning measurements. The positioning measurements are used by the UE or positioning node to determine the UE location. The positioning node communicates with UE and eNode B in LTE using LTE Positioning Protocol (LPP) and LPPa protocols respectively.

### Multi-Carrier or Carrier Aggregation Concept:

To enhance peak-rates within a technology, multi-carrier or carrier aggregation solutions are known. Each carrier in multi-carrier or carrier aggregation system is generally termed as a component carrier (CC) or sometimes it is also referred to as a cell. In simple words the component carrier (CC) means an individual carrier in a multi-carrier system. The term carrier aggregation (CA) is also called (e.g. interchangeably called) “multi-carrier system”, “multi-cell operation”, “multi-carrier operation”, “multi-carrier” transmission and/or reception. This means the CA is used for transmission of signaling and data in the uplink and downlink directions. One of the CCs is the primary component carrier (PCC) or simply primary carrier or even anchor carrier. The remaining ones are called secondary component carrier (SCC) or simply secondary carriers or even supplementary carriers. Generally the primary or anchor CC carries the essential UE specific signaling. The primary CC exists in both uplink and downlink direction CA. The network may assign different primary carriers to different UEs operating in the same sector or cell.

Therefore the UE has more than one serving cell in downlink and/or in the uplink: one primary serving cell and one or more secondary serving cells operating on the PCC and SCC respectively. The serving cell is interchangeably called primary cell (PCell) or primary serving cell (PSC). Similarly the secondary serving cell is interchangeably called as secondary cell (SCell) or secondary serving cell (SSC). Regardless of the terminology, the PCell and SCell(s) enable the UE to receive and/or transmit data. More specifically the PCell and SCell exist in DL and UL for the reception and transmission of data by the UE. The remaining non-serving cells on the PCC and SCC are called neighbor cells.

The CCs belonging to the CA may belong to the same frequency band (aka intra-band CA) or to different frequency band (inter-band CA) or any combination thereof (e.g. two CCs in band A and one CC in band B). Furthermore the CCs in intra-band CA may be adjacent or non-adjacent in frequency domain (aka intra-band non-adjacent CA). A hybrid CA comprising of intra-band adjacent, intra-band non-adjacent and inter-band is also possible. Using carrier aggregation between carriers of different radio access technologies (RATs) is also referred to as “multi-RAT carrier aggregation” or “multi-RAT-multi-carrier system” or simply “inter-RAT carrier aggregation”. For example, the carriers from Wideband Code Division Multiple Access (WCDMA) and LTE may be aggregated. Another example is the aggregation of LTE and CDMA2000 carriers. For the sake of clarity the carrier aggregation within the same technology as described can be regarded as ‘intra-RAT’ or simply ‘single RAT’ carrier aggregation.

The CCs in CA may or may not be co-located in the same site or base station or radio network node (e.g. relay, mobile relay etc). For instance the CCs may originate (i.e. transmitted/received) at different locations (e.g. from non-located BS or from BS and remote radio head (RRH) or remote radio unit (RRU)). The well known examples of combined CA and multi-point communication are DAS, RRH, RRU, CoMP, multi-point transmission/reception etc. The present disclosure also applies to the multi-point carrier aggregation systems. The multi-carrier operation may also be used in conjunction with multi-antenna transmission. For example signals on each CC may be transmitted by the eNB to the UE over two or more antennas.

The network using eICIC will have to provide the neighbor cell list to the UE when MBSFN ABS is used in aggressor cell(s) and/or whenever the network uses MBSFN data in a neighbor cell. The network provides very limited information about the subframes in which the MBSFN is actually used in neighbor cells. For example the network indicates that whether MBSFN configuration in the serving and neighbor cells is the same or different. Therefore without a neighbor cell list the UE assumes that MBSFN is used in MBSFN-configurable subframes in all neighbor cells. When MBSFN ABS is used then the restricted subframes are typically also MBSFN-configurable. Hence in the absence of a neighbor cell list the UE assumes that a restricted subframe (MBSFN-configurable) configured for measurements in a neighbor cell contains CRS only in symbol #0 of the first slot of this subframe. Due to this assumption the UE will perform the neighbor cell measurements (e.g. RSRP, RSRQ etc) in CRS only in one out of four OFDM symbols. This in turn results in degraded measurement performance. Therefore signaling of neighbor cell list is necessary whenever there is MBSFN in neighbor cell(s). However to ensure the neighbor cell list contains the correct cells considerable effort will be required in terms of network planning. Incorrect cells in the neighbor cell list may prevent the UE from reporting the measurements from neighbor cells, which are strong candidates for mobility (e.g. handover). Therefore due to incorrect neighbor cell list overall mobility performance will be deteriorated. A mechanism is needed to ensure the neighbor cell list contains correct list of cells.

### Example of a Method of Exchanging Information Between eNBs AND CREATION OF NEIGHBOR CELL LIST

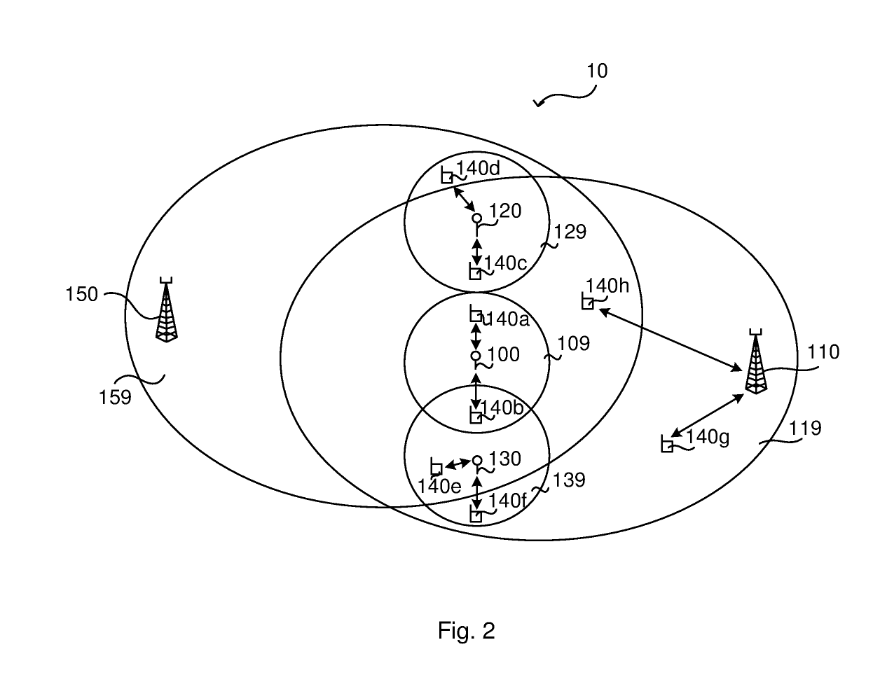

FIG. 2 schematically illustrates an embodiment of a heterogeneous communication system 10 in accordance with the present disclosure. The figure shows a geographical area covered by a macro cell 119 served by a macro radio network node 110. Parts of the area covered by the macro cell 119 has additional deployment of pico cells 109, 129 and 139, served by pico radio network nodes 100 (herein also called the second radio network node), 120 (herein also called the third radio network node) and 130 (herein also called the first radio network node), respectively, to form a heterogeneous network. Since the macro node 110 covers the same are as the pico nodes 100, 120 and 130, radio devices (UE) 140 served by the pico nodes risk experiencing interference from the macro node 110, which may then be regarded as an aggressor node. An exception is the UE 140d which is served by the pico node 120 but is beyond the aggressor cell 119. The macro node 110 (aggressor) may allocate an ABS pattern in order to reduce interference to the UEs served by the pico nodes. In the figure, eight UEs 140a-h are shown, but any number of UEs are possible and typically the number of UEs in such a heterogeneous network is much greater. Double-headed arrows indicate which radio network node each UE is connected to in the example of the figure. Thus, pico node 100 serves UEs 140a and 140b, pico node 120 serves UEs 140c and 140d, pico node 130 serves UEs 140e and 140f, and macro node 110 serves UEs 140g and 140h.

A second macro cell 159 served by the macro node 150 also covers the same area as covered by the pico nodes and may thus interfere with the UEs 140 served by the pico nodes. An exception is UE 14 of which is beyond the macro cell 159. Also macro node 150 is thus an aggressor to the victim pico cells and may allocate an ABS pattern to reduce interference to the UEs served by the pico cells. This ABS pattern may be identical or different to the ABS pattern allocated in the first macro cell 110. The UEs 140a, 140b, 140c and 140e risk being interfered by both of the macro nodes 110 and 150 and in accordance with embodiments of the present disclosure the respective measurement resource restriction patterns with which they are configured depend on the ABS patterns allocated in both macro cells 119 and 159. At the same time, UEs 140d and 140f only experience interference from one of the macro nodes, why measurement resource restriction patterns for each of these UEs should only need to be based on the one macro node which interferes with it. If the allocated ABS patterns of the macro nodes are different in relation to each other, it would thus unduly limit the measurement resource restriction patterns of the UEs only interfered by one of the macro nodes if the usable ABS pattern of its respective serving pico node is limited to subframes protected by both macro node ABS patterns. In this case it may be advantageous to construct an overall usable ABS pattern which includes subframes which are only present in one of the macro node ABS patterns, not necessarily both, allowing e.g. UE 140f to receive and use a measurement resource restriction pattern which only considers the ABS pattern of the first macro node 110.

A pico node connected UE may not only perform measurements on other pico nodes, but also on the macro nodes. The UEs 140a and 140b may e.g. use the protected subframes of the ABS pattern of the first macro cell 119 for performing measurements on the second macro cell 159.

In accordance with embodiments of the present disclosure, the pico nodes 100, 120 and 130 can signal information about their respective (overall) usable ABS pattern over an X2 interface to each other (and possibly also to the macro nodes). Thereby each radio network node can obtain a fuller picture of the interference situation in its environment.

As discussed herein, a UE uses its measurement resource restriction pattern for performing measurements on neighbouring cells, both pico and macro cells, to e.g. facilitate mobility. In FIG. 2, the UE 140b is connected to the pico node 100 but is also in range of pico node 130. The UE 140b can thus perform measurements on pico node 130 within the subframes of its measurement resource restriction pattern, when the interference from the macro nodes 110 and 150 is reduced or nullified by the allocated ABS patterns in the macro nodes. It is also noted that pico node 130 can interfere with UE 140b, illustrating that not only macro nodes are aggressors in the heterogeneous network 10. As discussed herein, a serving radio network node may prepare a neighbour cell list to its respective connected UEs. Thus, the UE 140b may receive a neighbour cell list comprising cell 139 which it can perform measurements on. Often, a UE can perform measurements on, and be interfered by, many neighbouring cells, but FIG. 2 has been simplified. In accordance with some embodiments of the present disclosure, whether or not a cell is added to a neighbour cell list depends on whether the (overall) usable ABS pattern of the neighbouring cell is the same (or overlapping) or not as the (overall) usable ABS pattern of the serving cell. Alternatively, such cells having same or overlapping usable ABS pattern may have a higher priority in the cell list than other cells. It may be advantageous for a UE 140 to primarily measure on, and e.g. eventually hand over to, other cells having similar ABS environment. The interference experienced by the UE may then also be reduced.

UEs 140g and 140h illustrate that UEs can be connected to a macro node, and may also be interfered (UE 140h) by another node, here macro node 150.

In some embodiments of the present disclosure, a neighbour cell 139 served by the first radio network node 130 is included in the neighbour cell list of the second radio network node 100 if the first usable ABS pattern of the first radio network node 130 at least partly overlaps with the second usable ABS pattern of the second radio network node 100.

In some embodiments of the present disclosure, a neighbour cell 139 served by the first radio network node 130 is included in the neighbour cell list of the second radio network node 100 if the first usable ABS pattern of the first radio network node 130 is included in, or the same as, the second usable ABS pattern of the second radio network node 100.

In some embodiments of the present disclosure, the second measurement resource restriction pattern configured by the second radio network node 100 contains only subframes which are included in the usable ABS pattern of all (each and every one of the) cells included in the neighbour cell list.

In some embodiments of the present disclosure, the second measurement resource restriction pattern configured by the second radio network node 100 is a subset of the subframes in the second usable ABS pattern of the second radio network node 100. A cell 139 served by the first radio network node 130 is then included in the neighbour cell list of the second radio network node 100 if the second measurement resource restriction pattern is a subset of subframes in the first usable ABS pattern of the first radio network node 130.

In some embodiments of the present disclosure, the second radio network node 100 sends a message to the second UE 140a; 140b, which it serves, including information about the second measurement resource restriction pattern configured by the second radio network node 100 and the neighbour cell list of the second radio network node 100, enabling the second UE to use the second measurement resource restriction pattern for performing measurements on the neighbour cell(s) 139 in the neighbour cell list. In some embodiments, the information about the neighbour cell list identifies only some, not all, of the neighbour cells 139 included in the neighbour cell list. In some embodiments, the information about the neighbour cell list, in addition to identifying the neighbour cells 139 included in the neighbour cell list, also comprises information about a priority level for the measurements on each of the cells included in the neighbour cell list. Thus it may be indicated to the UE 140 served by the second radio network node 100 which cell measurements should be prioritised above other cell measurements.

In some embodiments of the present disclosure, the second radio network node 100 sends a message comprising information about the neighbour cell list to at least one network node chosen from: positioning nodes; operations and maintenance, O&M, nodes; self organizing network, SON, nodes; operations support system, OSS, nodes; and minimization of drive tests, MDT, nodes. Thus, the network 10, e.g. the core network (CN) of the network 10 can be informed about the cell list and may thus obtain a fuller picture about the signalling environment at the second radio network node 100.

In some embodiments of the present disclosure, the second radio network node 100 receives a message from a third radio network node 120 serving a third UE 140c-d, comprising a third usable ABS pattern used by said third radio network node to configure the third UE with a third measurement resource restriction pattern for performing measurement on at least one neighbour cell. Then the preparing of the neighbour cell list in the second radio network node 100 is based also on the third usable ABS pattern.

In some embodiments of the present disclosure, the second radio network node 100 sends a first message comprising a request to a first radio network node 130, serving a first UE 140e-f, to transmit a second message comprising information about the first usable ABS pattern used by said first radio network node to configure the first UE with a first measurement resource restriction pattern for performing measurement on at least one neighbour cell 109. The first usable ABS pattern may consist of protected subframes overlapping with subframes comprised in at least one of a plurality of ABS patterns received from at least a first and a second interfering network node 110, 150 which can cause interference to the first UE. The second radio network node 100 may then receive a message comprising the information about e first usable ABS pattern used by the first radio network node from the first radio network node.

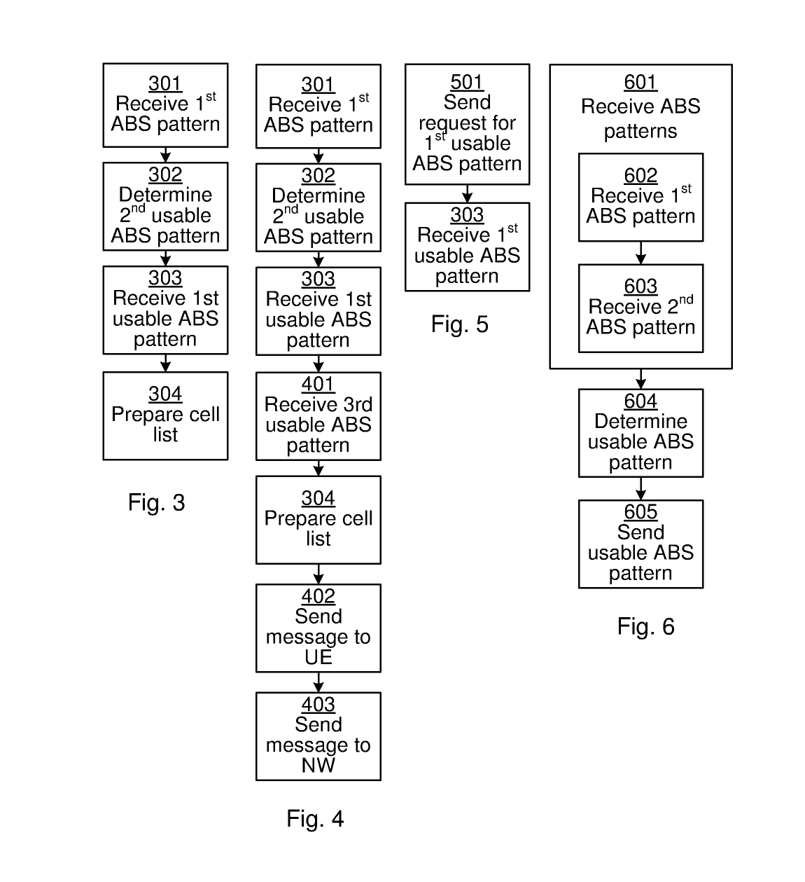

FIG. 3 is a schematic flow chart illustrating an embodiment of a method of the present disclosure. The method is performed in the second radio network node 100 discussed herein. A first message 2 is received 301 from an interfering radio network node 110; 150 which can cause interference to the second UE 140a; 140b, said first message comprising information about a first ABS pattern allocated in said interfering radio network node. A second usable ABS pattern is determined 302 by the second radio network node 100. The second usable ABS pattern comprises protected subframes overlapping with subframes comprised in the first ABS pattern. The second usable ABS pattern the can be used by the second radio network node 100 to configure the second UE 140a; 140b with a second measurement resource restriction pattern for performing measurement on at least one neighbour cell 119, 139, 159. A second message is received 303 from a first radio network node 130 serving a first UE 140e-f, comprising information about a first usable ABS pattern used by said first radio network node to configure the first UE with a first measurement resource restriction pattern for performing measurement on at least one neighbour cell 109, 119, 159. Based on the first usable ABS pattern, a neighbour cell list comprising neighbour cell(s) on which the second UE 140a; 140b should perform measurements in the second measurement resource restriction pattern is prepared 304 by the second radio network node 100.

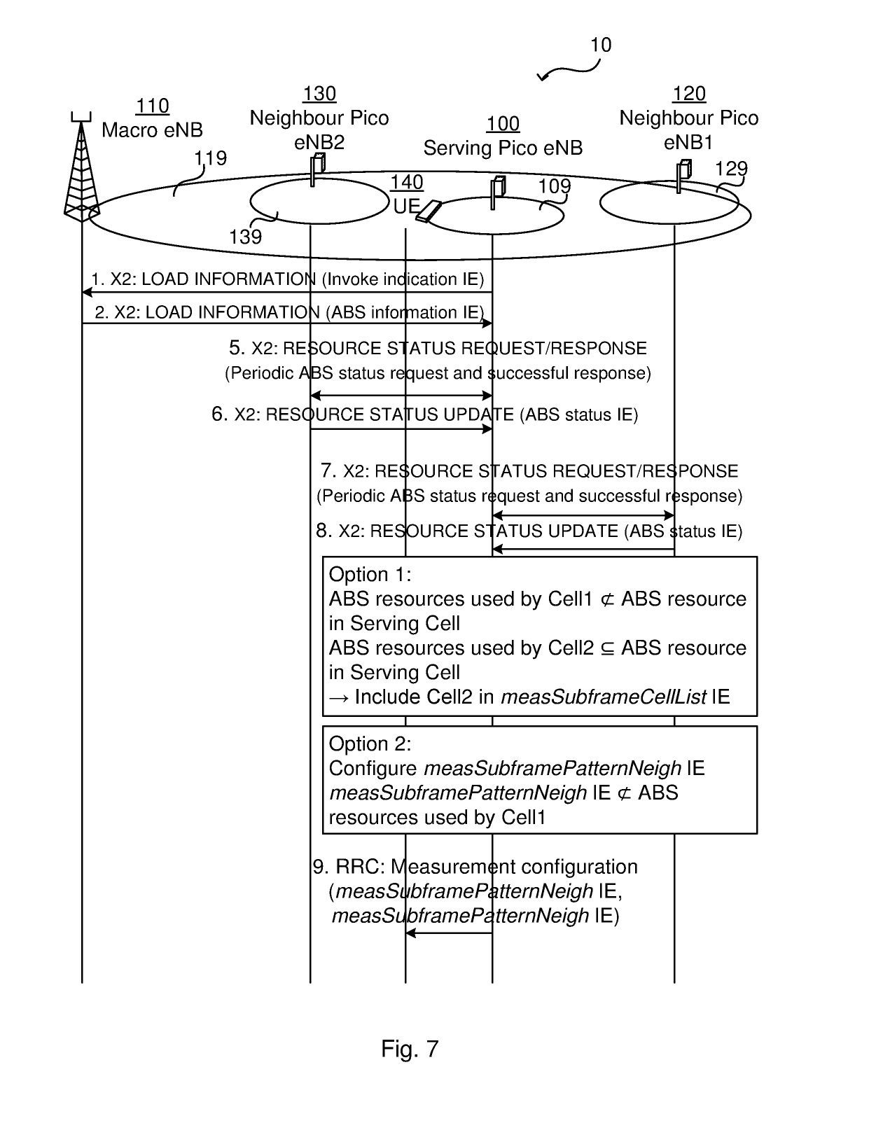

FIG. 4 is a schematic flow chart illustrating another embodiment of a method of the present disclosure. The method is performed in the second radio network node 100 discussed herein and comprises the steps of receiving 301 a first message, determining 302 a second usable ABS pattern, receiving 303 a second message, and preparing 304 a neighbour cell list as discussed with reference to FIG. 3. In addition, the method may comprise receiving 401 a message from a third radio network node 120 serving a third UE 140c-d. The message from the third radio network node 120 comprises a third usable ABS pattern used by said third radio network node to configure the third UE with a third measurement resource restriction pattern for performing measurement on at least one neighbour cell 109, 119, 159 (neighbouring to the third cell 129). The preparing 304 of the neighbour cell list can then be based also on the third usable ABS pattern. Additionally or alternatively, the method may comprise sending 402 a message 9 (see FIG. 7) to the second UE 140a; 140b including information about the second measurement resource restriction pattern and the neighbour cell list, enabling the second UE to use the second measurement resource restriction pattern for performing measurements on the neighbour cell(s) 139 in the neighbour cell list. Additionally or alternatively, the method may comprise sending 403 a message comprising information about the neighbour cell list to at least one network node chosen from: positioning nodes; operations and maintenance, O&M, nodes; self organizing network, SON, nodes; operations support system, OSS, nodes; and minimization of drive tests, MDT, nodes.

FIG. 5 is a schematic flow chart illustrating another embodiment of a method of the present disclosure. The method is performed in the second radio network node 100 discussed herein. A first message 5; 7 (see FIG. 7) comprising a request is sent 501 to a first radio network node 120; 130 serving a first UE 140c-f to transmit a second message 6; 8 (see FIG. 7) comprising information about a first usable ABS pattern used by said first radio network node to configure the first UE with a first measurement resource restriction pattern for performing measurement on at least one neighbour cell 109, 119, 159. The first usable ABS pattern consists of protected subframes overlapping with subframes comprised in at least one of a plurality of ABS patterns received from at least a first and a second interfering network node 110, 150 which can cause interference to the first UE. Thus, all the subframes of the first usable ABS pattern are included in at least one of the ABS patterns of the plurality of interfering network nodes 110, 150. Then the second message 6; 8 is received 303 from the first radio network node. This corresponds to the receiving 303 a message comprising information about the first usable ABS pattern discussed in relation to FIG. 3. Additionally, method steps of FIG. 3 or 4 can be performed as discussed in relation to those figures. For instance, a second usable ABS pattern can be determined 302. Wherein the second usable ABS pattern comprises protected subframes overlapping with subframes comprised in the first ABS pattern. The usable ABS pattern can be used by the second radio network node 100 configure the second UE 140a; 140b with a second measurement resource restriction pattern for performing measurement on at least one neighbour cell 119, 139, 159. Additionally or alternatively a neighbour cell list comprising neighbour cell(s) on which the second UE should perform measurements in the second measurement resource restriction pattern, can be prepared 304 based on the first usable ABS pattern.

FIG. 5 is a schematic flow chart illustrating another embodiment of a method of the present disclosure. The method is performed in the first radio network node 130 discussed herein. Information about a plurality of ABS patterns allocated in interfering radio network nodes 110; 150 which can cause interference to a first UE served by the first radio network node 130 is received 601. This information is received 601 by receiving 602 a message 2 from a first interfering radio network node 110 which can cause interference to the first UE 140e, said first message comprising information about a first ABS pattern allocated in said first interfering radio network node 110; and by receiving 603 a message from a second interfering radio network node 150 which can cause interference to the first UE 140e, said second message comprising information about a second ABS pattern allocated in said second interfering radio network node 150. A usable ABS pattern is determined 604. The usable ABS pattern consists of protected subframes overlapping with subframes comprised in the plurality of ABS patterns, which usable ABS pattern the first radio network node 130 can use to configure the first UE 140e with a first measurement resource restriction pattern for performing measurement on at least one neighbour cell 109. A message 6 (see FIG. 7) comprising information about the determined usable ABS pattern is sent 604 to a second radio network node 100.

In the description above, it was highlighted that a current problem is about how to configure a UE 140 with a neighbor cell list containing neighbor cells that can be measured during measurement resource restriction patterns. Such a neighbor cell list is referred in TS 36.331 as measSubframeCellList IE.

Upon measurement configuration by serving eNB 100, the cells included in the measSubframeCellList IE will be measured by the UE 140 in subframes listed in the measSubframePatternNeigh IE (see TS 36.331). It has to be noted that the measSubframePatternNeigh IE is a subset of the ABS pattern allocated to the serving eNB 100 by its aggressor(s) 110, 150.

To allow for correct measurements of neighbor cells 120, 130 in the measSubframeCellList IE, it is needed that such cells are sharing the same ABS resources as the serving eNB 100 and in particular it is needed that the neighbor cells are using ABS patterns that include the resource restriction measurement pattern in the measSubframePatternNeigh IE. Therefore, correct configuration of cells in the measSubframeCellList IE depends on whether such cells share the same ABS resources as serving eNB 100 and in particular if such ABS resources include the measSubframePatternNeigh IE.

To achieve the above, according to an embodiment, the present disclosure proposes to enable X2 connected neighbor eNBs 120, 130 to trigger X2: RESOURCE STATUS UPDATE messages reporting the ABS Status IE. Once the serving eNB 100 receives ABS Status IEs from all neighbor cells, it will know which cells are sharing common ABS patterns and whether such patterns can include or overlap the pattern in measSubframePatternNeigh IE. Certain victim eNB (e.g. pico eNB 100) may have more than one aggressor eNB (e.g. two aggressor macro eNBs 110, 150) interfering with the UE downlink reception from the victim eNB. In this case, an independent ABS pattern is configured in each aggressor eNB 110, 150. The ABS patterns in different aggressor eNBs, though, may be the same or different. The victim eNB 100 is aware of the ABS patterns in each of its aggressor eNBs and (depending on the interference monitored on each subframe resource) it will decide to use an ABS pattern that may be made of some or all ABS subframes allocated by one or more aggressors. Therefore upon triggering of the X2: RESOURCE STATUS UPDATE messages, the neighboring eNBs 120, 130 may report to the serving eNB 100, the ABS Status IE containing the ABS patterns used by the neighbor eNB and made of part or all of the ABS patterns allocated by each of its aggressor eNB 110, 150. The information related to ABS patterns in different aggressor eNBs can be sent by the neighboring eNB to serving eNB in the same message or in different messages.

If neighbor cells are not utilising ABS patterns including the pattern in the measSubframePatternNeigh IE, then such cells may not be configured in the measSubframeCellList IE.

The procedure as described in this embodiment can be applied for creating the neighbor cell list (measSubframeCellList IE) for UEs in radio resource control (RRC) connected state or for the UEs in low activity state (e.g. RRC IDLE state).

An example of how such embodiment could be supported in the 3GPP specification TS 36.423 could consist of modifying the following sentence in section 8.3.6.2 of the 3GPP standard:

“For each cell, the eNB2 shall include in the RESOURCE STATUS UPDATE message:

the ABS Status IE, if the fifth bit, “ABS Status Periodic” of the Report Characteristics IE included in the RESOURCE STATUS REQUEST message is set to 1 and eNB, had indicated the ABS pattern to eNode B”

The sentence above could be modified in the following:

“For each cell, the eNB2 shall include in the RESOURCE STATUS UPDATE message:

the ABS Status IE, if the fifth bit, “ABS Status Periodic” of the Report Characteristics IE included in the RESOURCE STATUS REQUEST message is set to 1”

The above would allow reporting of ABS Status IE in the X2: RESOURCE STATUS UPDATE message between any X2 connected eNB and therefore allow the mechanisms described above to function.

A graphical example of how the mechanism proposed in this first embodiment may work is provided in FIG. 7. In FIG. 7 the message sequence chart steps can be described as follows:

1) Serving Pico eNB 100 invokes ABS resources (i.e. ABS pattern) allocated to aggressor Macro eNB 110.

2) Serving Pico eNB 100 receives ABS patterns from aggressor eNB 110.

5) Serving Pico eNB 100 sends X2: RESOURCE STATUS REQUEST to Neighbor Pico eNB2 130, requesting for periodic ABS Status reports. Neighbor Pico eNB2 acknowledges the request via X2: RESOURCE STATUS RESPONSE

6) Neighbor Pico eNB2 130 starts sending X2: RESOURCE STATUS UPDATE to serving eNB 100, including ABS Status IE

7) Serving Pico eNB 100 sends X2: RESOURCE STATUS REQUEST to Neighbor Pico eNB1 120, requesting for periodic ABS Status reports. Neighbor Pico eNB1 acknowledges the request via X2: RESOURCE STATUS RESPONSE

8) Neighbor Pico eNB1 120 starts sending X2: RESOURCE STATUS UPDATE to serving eNB 100, including ABS Status IE

After step 8, several options (numbered 1-4 below) are possible; they are disclosed below:

### Option 1:

Serving Pico eNB 100 monitors whether the ABS resources used by each neighbor Pico cell 120, 130 are a subset of the ABS resources used in serving Pico cell 100.
Neighbor cells 120, 130 for which the ABS resources in use are a subset of the ABS resources used at serving Pico cell 100 are included in the measSubframeCellList IE.
measSubframePatternNeigh IE is configured in a way to be included in each ABS pattern used by neighbor cells included in measSubframeCellList IE.

In this option, the cells included in the measSubframeCellList IE are the cells that use a pattern of ABS resources included or equal to the pattern used by serving cell. The measSubframePatternNeigh IE is constructed by ensuring that it is included in every pattern of ABS resources used by cells in the measSubframeCellList IE.

Note: a variation of Option 1 (not shown in FIG. 7) could be as follows.

### Option 1a:

Serving Pico eNB monitors whether the ABS resources used by each neighbor Pico cell have any resources in common with the ABS resources used in serving Pico cell.
Neighbor cells for which some ABS resources in use are in common with the ABS resources used at serving Pico cell are included in the measSubframeCellList IE.
measSubframePatternNeigh IE is configured in a way to be included in the ABS pattern in common to all neighbor cells included in measSubframeCellList IE.

In this option, the cells included in the measSubframeCellList IE are the cells that use ABS resources at least partly overlapping with the ABS resources used by serving cell 100. The measSubframePatternNeigh IE is constructed by ensuring that it is included in the pattern of ABS resources in common to all cells 120, 130 in the measSubframeCellList IE. The difference with Option 1 is in the possibility to include more cells in the measSubframeCellList IE. However, this will incur in a potentially reduced measSubframePatternNeigh IE.

### Option 2:

measSubframePatternNeigh IE is configured as a subset of usable ABS resources allocated by aggressor eNBs 110, 150.
Serving Pico eNB 100 monitors whether the ABS resources used in measSubframePatternNeigh IE are included in ABS resources used in each neighbor Pico cell 120, 130.
Neighbor cells for which the ABS resources used in measSubframePatternNeigh IE are included in ABS resources in use are included in the measSubframeCellList IE.

In this option, the measSubframePatternNeigh IE is first configured as a subset of common ABS resources allocated to serving eNB 100 by aggressor eNBs 110, 150. The list of cells 120, 130 to be included in the measSubframeCellList IE is made of cells using ABS resources included in the measSubframePatternNeigh IE configured by serving eNB 100. This option differs from option 1 and option 1a in the fact that selection of cells to be included in the measSubframeCellList IE depends on how the measSubframePatternNeigh IE has been previously configured by serving cell.

### Option 3:

This option uses a combination of procedures used in any of options 1, 1a or 2 and additional criteria to include the neighbor cells in the final measSubframeCellList IE, which is to be signaled to the UE 140 for neighbor cell restricted measurements. This is further described below:
In the first step, the serving eNB 100 creates the first measSubframeCellList IE according to any of the options 1, 1a and 2.
In the second step, the serving eNB 100 takes into account one or more of the following criteria to decide whether all or subset of cells in the first measSubframeCellList IE should be signalled to the UE 140:
UE location and/or UE relative location in serving cell 109 e.g. when close to the serving cell, neighbor cells far out from the serving cell can be excluded.
UE signal measurement performed on the signal from the serving cell 109 e.g. if signal strength is below a threshold then serving eNB 100 may include all cells 120, 130 in the first measSubframeCellList IE, otherwise it may exclude one or more neighbor cells which are relatively far away.
Number of cells in the first cell list (first measSubframeCellList IE) e.g. if the number of cells in the first list is smaller than a threshold (e.g. seven) then the second list is the same as the first neighbor cell list. Otherwise the serving eNB 100 may use location and/or UE measurement criteria for creating the final second neighbor cell list.
Based on the criteria in the second step, the serving eNB 100 creates the second measSubframeCellList IE, which may the same as the first measSubframeCellList IE in first step or subset of it.

### Option 4:

This option is similar to option 3 except that cells which were found to be excluded in the second step based on criteria are included in the second neighbor cell lists but these cells are considered to be of lower priority. For example, the PeNB can tag these cells with a priority level lower than that of the remaining cells.
The serving eNB 100 creates a second measSubframeCellList IE containing cells with associated priority levels as described above. Such list may either consist of a new version of previously signalled measSubframeCellList IE or it may consist of a newly specified information element signalled to the UE 140.
As a consequence, the UE 140 upon receiving the second measSubframeCellList IE and measSubframePatternNeigh IE initially performs measurements on the neighbor cells with higher priority. The lower priority cells may be measured by the UE at a later stage or in a best effort manner (e.g. whenever UE has resources to measure these cells). The measurements performed on the lower priority cells may also be required to meet less stringent performance requirements. For example the pre-defined measurement period of a measurement (e.g. cell search, Reference Signal Received Power (RSRP), Reference Signal Received Quality (RSRQ) periods etc) may be longer than that performed on a higher priority cell.

Step 9: Serving Pico eNB 100 sends an RRC: Measurement Configuration message including measSubframePatternNeigh IE and measSubframeCellList IE
The serving Pico eNB 100 sends the above mentioned information to each UE 140 separately on a dedicated logical control channel (e.g. RRC message on a dedicated control channel (DCCH)) in RRC connected state. The pico eNB may also send the above information via a common logical control channel (e.g. RRC message on a common control channel (CCCH)) to all or a group of UEs in idle state.

Additional, optional step: Serving Pico eNB 100 sends 403 messages or related information comprises in the measSubframePatternNeigh IE and measSubframeCellList IE to other network nodes over a suitable interface, which may use them for network management tasks or radio operational tasks. The information may be signaled to other network nodes proactively or in response to a request received from the target network node. Examples of such tasks are network planning, tuning of radio parameters, etc. Examples of other nodes are positioning node (e.g. to E-SMLC in LTE over LPPa), operations and maintenance (O&M), self organizing network (SON) node, operations support system (OSS) node, minimization of drive tests (MDT) node etc.
For example, the positioning node may use the received information to create a neighbor cell list when requesting UE to perform measurements for positioning (e.g. RSRP/RSRQ etc for fingerprinting or Enhanced cell ID positioning).
The other nodes, such as SON or OSS, may use the received information for network planning, configuration and tuning of network parameters, setup, upgrade or modification of low and/or high power nodes in a coverage area etc.
O&M nodes, by virtue of knowing ABS pattern configurations in macro cells, may be able to deduce how victim cells are utilizing the ABS patterns allocated by their aggressors. This can be achieved by using the measSubframePatternNeigh IE and measSubframeCellList IE in conjunction with information about the neighbor cells of the node reporting the information. Consequently, if a low ABS pattern utilization is monitored, the O&M or OSS system may reconfigure ABS patterns in macro cell aggressors, or indeed in any monitored aggressor cell, in order to improve ABS pattern usability by victim eNBs.

The embodiments discussed above are described by considering examples in which a serving eNB 100 is assumed to be a pico eNB, neighboring eNBs 120, 130 are assumed to be pico eNBs and aggressor eNB(s) 110, 150 are assumed to be macro eNBs. However the embodiments are not limited to pico and macro eNB scenarios, as described below:

In one example, the serving eNB 100 (aka serving cell), neighbor eNBs 120, 130 (aka neighboring cells) may be any type of lower power nodes and aggressor eNB 110, 150 (aka aggressor cell) may be any type of high power node. Examples of lower power nodes are local area base station (aka pico BS as it serves a pico cell), medium range base station (aka micro BS as it serves a micro cell), femto or home base station (aka femto cell as it serves a femto cell).

In yet another example, the serving eNB 100 can be even a high power node e.g. macro eNB. For example, a serving macro eNB 100 may signal the measurement pattern and the neighbor cell list for enabling the UE 140 to perform measurements on cells served by lower power nodes 120, 130 (e.g. pico eNBs) which are interfered by an aggressor cell. The aggressor cell can be the serving macro eNB 100 itself or another macro eNB 110, 150.

The embodiments discussed above are described for specific patterns (e.g. ABS configured in aggressor cell 110, 150 and restricted pattern neighbor victim cells 100, 120, 130). However the embodiments are equally applicable to other signal transmit pattern comprising of lower power or low interference subframes. The embodiments are also equally applicable to other signal transmit pattern comprising of lower power or low interference time-frequency resources (e.g. certain RBs in certain time slots or subframes).

The embodiments discussed above also apply to exchanging signaling between any set of radio nodes operating in an heterogeneous network for the purpose of creating a neighbor cell list when a measurement pattern is used by the UE 140 for doing neighbor cell measurements.

The embodiments discussed above also applies for each serving cell or each carrier used by the UE 140 when the UE operates in multi-cell scenarios. Examples of multi-cell scenarios are carrier aggregation or multi-carrier, multi cell coordinated multipoint transmission (CoMP), CoMP with carrier aggregation etc. The method may be applied for each cell or carrier independently or jointly depending upon the multi-cell scenario. For example in carrier aggregation each carrier typically has a different aggressor cell whereas in CoMP with single carrier all serving cells may have the same aggressor cell.

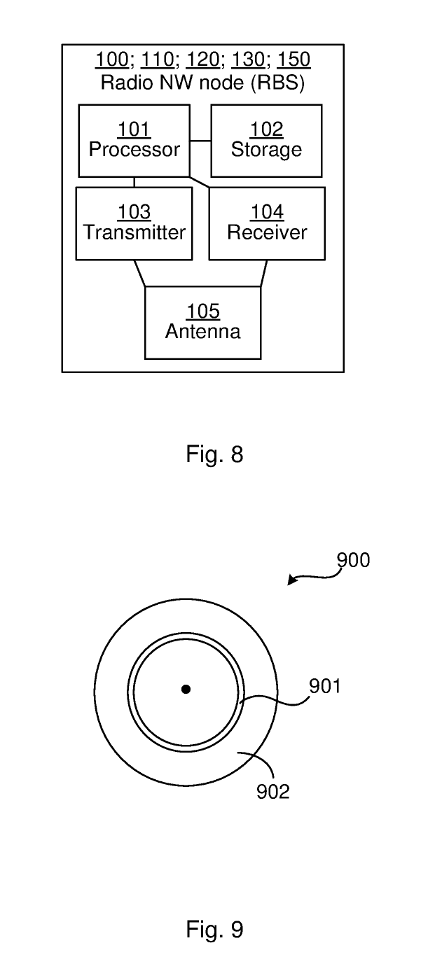

FIG. 8 schematically illustrates an embodiment of a network node or radio base station (RBS) 100 of the present disclosure. The radio network node illustrated in FIG. 8 may represent any of the radio network nodes 100, 110, 120, 130, 150 discussed herein. The radio network node 100 comprises a processor or central processing unit (CPU) 101. The processor 101 may comprise one or a plurality of processing units in the form of microprocessor(s). However, other suitable devices with computing capabilities could be used, e.g. an application specific integrated circuit (ASIC), a field programmable gate array (FPGA) or a complex programmable logic device (CPLD). The processor 101 is configured to run one or several computer program(s) or software stored in a storage unit or memory 102. The storage unit is regarded as a computer readable means and may e.g. be in the form of a Random Access Memory (RAM), a Flash memory or other solid state memory, or a hard disk. The processor 101 is also configured to store data in the storage unit 102, as needed. The radio network node 100 also comprises a transmitter 103, a receiver 104 and an antenna 105, which may be combined to form a transceiver or be present as distinct units within the radio network node 100. The transmitter 103 is configured to cooperate with the processor to transform data bits to be transmitted over a radio interface to a suitable radio signal in accordance with the radio access technology (RAT) used by the radio access network (RAN) via which the data bits are to be transmitted. The receiver 104 is configured to cooperate with the processor 101 to transform a received radio signal to transmitted data bits. The antenna 105 may comprise a single antenna or a plurality of antennas, e.g. for different frequencies and/or for MIMO (Multiple Input Multiple Output) communication. The antenna 105 is used by the transmitter 103 and the receiver 104 for transmitting and receiving, respectively, radio signals. The processor is also configured for performing any embodiment of a method discussed herein.

FIG. 9 illustrates an embodiment of a computer program product 900 according to the present disclosure. The computer program product 900 comprises a computer readable medium 902 comprising a computer program 901 in the form of computer-executable components 901. The computer program/computer-executable components 901 may be configured to cause a radio network node 100, 120, 130, e.g. as discussed above, to perform an embodiment of a method of the present disclosure. The computer program/computer-executable components may be run by the processor circuitry 101 of the node for causing the node to perform the method. The computer program product 900 may e.g. be comprised in a storage unit 102 or memory comprised in the node and associated with the processor circuitry 101. Alternatively, the computer program product 900 may be, or be part of, a separate, e.g. mobile, storage means, such as a computer readable disc, e.g. CD or DVD or hard disc/drive, or a solid state storage medium, e.g. a RAM or Flash memory.

Below follow some other aspects and embodiments of the present disclosure.

According to an aspect of the present disclosure, there is provided a second radio network node (100) configured for serving a second UE (140a; 140b). The second radio network node comprises means (101) for receiving (301) a first message (2) from an interfering radio network node (110; iso) which can cause interference to the second UE, said first message comprising information about a first ABS pattern allocated in said interfering radio network node. The second radio network node also comprises means (101) for determining (302) a second usable ABS pattern, said second usable ABS pattern comprising protected subframes overlapping with subframes comprised in the first ABS pattern, which second usable ABS pattern the second radio network node (100) can use to configure the second UE (140a; 140b) with a second measurement resource restriction pattern for performing measurement on at least one neighbour cell (119, 139, 159). The second radio network node also comprises means (101) for receiving (303) a second message (8) from a first radio network node (120; 130) serving a first UE (140c-f), comprising information about a first usable ABS pattern used by said first radio network node to configure the first UE with a first measurement resource restriction pattern for performing measurement on at least one neighbour cell (109, 119, 159). The second radio network node also comprises means (101) for preparing (304), based on the first usable ABS pattern, a neighbour cell list comprising neighbour cell(s) on which the second UE (140a; 140b) should perform measurements in the second measurement resource restriction pattern.

According to another aspect of the present disclosure, there is provided a second radio network node (100) configured for serving a second UE (140a; 140b). The second radio network node comprises means (100) for sending (501) a first message (5; 7) comprising a request to a first radio network node (120; 130) serving a first UE (140c-f) to transmit a second message (6; 8) comprising information about a first usable ABS pattern used by said first radio network node to configure the first UE with a first measurement resource restriction pattern for performing measurement on at least one neighbour cell (109, 119, 159); wherein the first usable ABS pattern consists of protected subframes overlapping with subframes comprised in at least one of a plurality of ABS patterns received from at least a first and a second interfering network node (no, 150) which can cause interference to the first UE. The second radio network node also comprises means (100) for receiving (303) the second message (6; 8) from the first radio network node (120; 130).

According to another aspect of the present disclosure, there is provided a first radio network node (130) configured for serving a first UE (140e). The first radio network node comprises means (101) for receiving (601) information about a plurality of ABS patterns allocated in interfering radio network nodes (110; iso) which can cause interference to the first UE. The receiving (601) comprises receiving (602) a message (2) from a first interfering radio network node (110) which can cause interference to the first UE (140e), said first message comprising information about a first ABS pattern allocated in said first interfering radio network node (110); and receiving (603) a message from a second interfering radio network node (150) which can cause interference to the first UE (140e), said second message comprising information about a second ABS pattern allocated in said second interfering radio network node (150). The first radio network node comprises means (101) for determining (604) a usable ABS pattern, said usable ABS pattern consisting of protected subframes overlapping with subframes comprised in the plurality of ABS patterns, which usable ABS pattern the first radio network node (130) can use to configure the first UE (140e) with a first measurement resource restriction pattern for performing measurement on at least one neighbour cell (109). The first radio network node comprises means (101) for sending (604) a message (6) comprising information about the determined usable ABS pattern to a second radio network node (100).

According to an aspect of the present invention, there is provided a method in which a base station (100) which has not invoked protected resources allocation to another neighbor (120; 130) base station, or has not allocated protected resources upon request from such a neighbor base station, is enabled to exchange messages with such neighbor base station for the purpose of gathering information about patterns of protected resources utilized in a neighbor (129; 139) cell served by the neighbor base station.

In some embodiments, the base station (100) gathering information about the patterns of protected resources utilized by neighbor cells (129; 139) served by neighbor base stations (120; 130) serves a user equipment (140a; 140b).

In some embodiments, the base station (100) serves a user equipment (140a; 140b) and selects cells (139) to be included in a neighbor cell list for the purpose of being measured by the user equipment during configured resource patterns.

In some embodiments, the cells (139) included in the neighbour cell list are selected on the basis of sharing part or all of the protected resources used by the cell (100) serving the user equipment (140b).

In some embodiments, the pattern of resources on which neighbour cells included in the neighbour cell list have to be measured by the user equipment (140b) is either included or is the same as the commonly shared pattern of protected resources used by serving cell (100) and neighbour cells (130).

In some embodiments, the neighbor cell list and measurement patterns calculated by serving cell (100) are transmitted to other network components for the purpose of evaluating whether coordination of protected resource patterns is needed amongst aggressor cells (110, 150).

According to an aspect of the present invention, there is provided a network node or base station (100) of a radio communication system, comprising a processor (101), a radio receiver (104), a radio transmitter (103), an antenna (105) and a storage unit (102). The processor (101) is configured for performing any embodiment of a method of the present disclosure.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method in a second radio network node serving a second user equipment, UE, the method comprising:
receiving a first message from an interfering radio network node which can cause interference to the second UE, said first message comprising information about a first almost blank subframe, ABS, pattern allocated in said interfering radio network node;
determining a second usable ABS pattern, said second usable ABS pattern comprising protected subframes overlapping with subframes comprised in the first ABS pattern, which second usable ABS pattern the second radio network node can use to configure the second UE with a second measurement resource restriction pattern for performing measurement on at least one neighbour cell;
receiving a second message from a first radio network node serving a first UE, comprising information about a first usable ABS pattern used by said first radio network node to configure the first UE with a first measurement resource restriction pattern for performing measurement on at least one neighbour cell; and
preparing, based on the first usable ABS pattern, a neighbour cell list comprising neighbour cell(s) on which the second UE should perform measurements in the second measurement resource restriction pattern.

2. The method of claim 1, wherein a neighbour cell served by the first radio network node is included in the neighbour cell list based on the first usable ABS pattern at least partly overlapping the second usable ABS pattern.

3. The method of claim 1, wherein a neighbour cell served by the first radio network node is included in the neighbour cell list based on the first usable ABS pattern being included in, or the same as, the second usable ABS pattern.

4. The method of claim 1, wherein the second measurement resource restriction pattern contains only subframes which are included in the usable ABS pattern of all cells included in the neighbour cell list.

5. The method of claim 1, wherein the second measurement resource restriction pattern is a subset of the subframes in the second usable ABS pattern; and a cell served by the first radio network node is included in the neighbour cell list based on the second measurement resource restriction pattern being a subset of subframes in the first usable ABS pattern.

6. The method of claim 1, further comprising:
sending a message to the second UE including information about the second measurement resource restriction pattern and the neighbour cell list, enabling the second UE to use the second measurement resource restriction pattern for performing measurements on the neighbour cell(s) in the neighbour cell list.

7. The method of claim 6, wherein the information about the neighbour cell list identifies only some, not all, of the neighbour cells included in the neighbour cell list.

8. The method of claim 6, wherein the information about the neighbour cell list, in addition to identifying the neighbour cells included in the neighbour cell list, also comprises information about a priority level for the measurements on each of the cells included in the neighbour cell list.

9. The method of claim 1, further comprising:
sending a message comprising information about the neighbour cell list to at least one network node chosen from: positioning nodes; operations and maintenance, O&M, nodes; self organizing network, SON, nodes; operations support system, OSS, nodes; and
minimization of drive tests, MDT, nodes.

10. The method of claim 1, further comprising:
receiving a message from a third radio network node serving a third UE, comprising a third usable ABS pattern used by said third radio network node to configure the third UE with a third measurement resource restriction pattern for performing measurement on at least one neighbour cell;
wherein the preparing of the neighbour cell list is based also on the third usable ABS pattern.

11. A method in a second radio network node serving a second user equipment, UE, the method comprising:
sending a first message comprising a request to a first radio network node serving a first UE to transmit a second message comprising information about a first usable ABS pattern used by said first radio network node to configure the first UE with a first measurement resource restriction pattern for performing measurement on at least one neighbour cell; wherein the first usable ABS pattern consists of protected subframes overlapping with subframes comprised in at least one of a plurality of ABS patterns received from at least a first and a second interfering network node which can cause interference to the first UE; and
receiving the second message from the first radio network node.

12. The method of claim 11, further comprising:
determining a second usable ABS pattern, said second usable ABS pattern comprising protected subframes overlapping with subframes comprised in the first ABS pattern, which usable ABS pattern the second radio network node can use to configure the second UE with a second measurement resource restriction pattern for performing measurement on at least one neighbour cell; and
preparing, based on the first usable ABS pattern, a neighbour cell list comprising neighbour cell(s) on which the second UE should perform measurements in the second measurement resource restriction pattern.

13. A computer program product comprising computer-executable components for causing a second radio network node to perform the method of claim 1, when the computer-executable components are run on processor circuitry comprised in the second radio network node.

14. A second radio network node configured for serving a second user equipment, UE, the second radio network node comprising:
processor circuitry; and
a storage unit storing instructions that, when executed by the processor circuitry, cause the second radio network node to:
receive a first message from an interfering radio network node which can cause interference to the second UE, said first message comprising information about a first almost blank subframe, ABS, pattern allocated in said interfering radio network node;
determine a second usable ABS pattern, said second usable ABS pattern comprising protected subframes overlapping with subframes comprised in the first ABS pattern, which usable ABS pattern the second radio network node can use to configure the second UE with a second measurement resource restriction pattern for performing measurement on at least one neighbour cell;
receive a second message from a first radio network node serving a first UE, comprising information about a first usable ABS pattern used by said first radio network node to configure the first UE with a first measurement resource restriction pattern for performing measurement on at least one neighbour cell; and
prepare, based on the first usable ABS pattern, a neighbour cell list comprising neighbour cell(s) on which the second UE should perform measurements in the second measurement resource restriction pattern.

15. A second radio network node configured for serving a second user equipment, UE, the second radio network node comprising:
processor circuitry; and
a storage unit storing instructions that, when executed by the processor circuitry, cause the second radio network node to:
send a first message comprising a request to a first radio network node serving a first UE to transmit a second message comprising information about a first usable ABS pattern used by said first radio network node to configure the first UE with a first measurement resource restriction pattern for performing measurement on at least one neighbour cell; wherein the first usable ABS pattern consists of protected subframes overlapping with subframes comprised in at least one of a plurality of ABS patterns received from at least a first and a second interfering network node which can cause interference to the first UE; and
receive the second message from the first radio network node.

16. A computer program product comprising a non-transitory computer readable medium storing program code which, when run on processor circuitry of a second radio network node serving a second user equipment, UE, cause the second radio network node to:
receive a first message from an interfering radio network node which can cause interference to the second UE, said first message comprising information about a first almost blank subframe, ABS, pattern allocated in said interfering radio network node;
determine a second usable ABS pattern, said second usable ABS pattern comprising protected subframes overlapping with subframes comprised in the first ABS pattern, which usable ABS pattern the second radio network node can use to configure the second UE with a second measurement resource restriction pattern for performing measurement on at least one neighbour cell;
receive a second message from a first radio network node serving a first UE, comprising information about a first usable ABS pattern used by said first radio network node to configure the first UE with a first measurement resource restriction pattern for performing measurement on at least one neighbour cell; and
prepare, based on the first usable ABS pattern, a neighbour cell list comprising neighbour cell(s) on which the second UE should perform measurements in the second measurement resource restriction pattern.

17. A computer program product comprising a non-transitory computer readable medium storing program code which, when run on processor circuitry of a second radio network node serving a second user equipment, UE, cause the second radio network node to:
send a first message comprising a request to a first radio network node serving a first UE to transmit a second message comprising information about a first usable ABS pattern used by said first radio network node to configure the first UE with a first measurement resource restriction pattern for performing measurement on at least one neighbour cell; wherein the first usable ABS pattern consists of protected subframes overlapping with subframes comprised in at least one of a plurality of ABS patterns received from at least a first and a second interfering network node which can cause interference to the first UE; and
receive the second message from the first radio network node.

18. A method in a first radio network node serving a first user equipment, UE, the method comprising:
receiving information about a plurality of almost blank subframe, ABS, patterns allocated in interfering radio network nodes which can cause interference to the first UE, comprising:
receiving a message from a first interfering radio network node which can cause interference to the first UE, said first message comprising information about a first ABS pattern allocated in said first interfering radio network node; and
receiving a message from a second interfering radio network node which can cause interference to the first UE, said second message comprising information about a second ABS pattern allocated in said second interfering radio network node;
determining a usable ABS pattern, said usable ABS pattern consisting of protected subframes overlapping with subframes comprised in the plurality of ABS patterns, which usable ABS pattern the first radio network node can use to configure the first UE with a first measurement resource restriction pattern for performing measurement on at least one neighbour cell; and
sending a message comprising information about the determined usable ABS pattern to a second radio network node.

19. A computer program product comprising a non-transitory computer readable medium storing program code which, when run on processor circuitry in a first radio network node, causes the first radio network node to perform the method of claim 18.

20. A first radio network node configured for serving a first user equipment, UE, the first radio network node comprising:
processor circuitry; and
a storage unit storing instructions that, when executed by the processor circuitry, cause the first radio network node to:
receive information about a plurality of almost blank subframe, ABS, patterns allocated in interfering radio network nodes which can cause interference to the first UE, comprising:
receiving a message from a first interfering radio network node which can cause interference to the first UE, said first message comprising information about a first ABS pattern allocated in said first interfering radio network node; and
receiving a message from a second interfering radio network node which can cause interference to the first UE, said second message comprising information about a second ABS pattern allocated in said second interfering radio network node;
determine a usable ABS pattern, said usable ABS pattern consisting of protected subframes overlapping with subframes comprised in the plurality of ABS patterns, which usable ABS pattern the first radio network node can use to configure the first UE with a first measurement resource restriction pattern for performing measurement on at least one neighbour cell; and
send a message comprising the determined usable ABS pattern to a second radio network node.

21. A computer program for a first radio network node-product comprising a non-transitory computer readable medium storing program code which, when run on processor circuitry of a first radio network node serving a first user equipment, UE, cause the first radio network node to:
receive information about a plurality of almost blank subframe, ABS, patterns allocated in interfering radio network nodes which can cause interference to the first UE, comprising:
receiving a message from a first interfering radio network node which can cause interference to the first UE, said first message comprising information about a first ABS pattern allocated in said first interfering radio network node; and
receiving a message from a second interfering radio network node which can cause interference to the first UE, said second message comprising information about a second ABS pattern allocated in said second interfering radio network node;
determine a usable ABS pattern, said usable ABS pattern consisting of protected subframes overlapping with subframes comprised in the plurality of ABS patterns, which usable ABS pattern the first radio network node can use to configure the first UE with a first measurement resource restriction pattern for performing measurement on at least one neighbour cell; and
send a message comprising the determined usable ABS pattern to a second radio network node.

22. (canceled)
